(19) United States
(12) Patent Application Publication
(10) Pub. No.: US 2007/0294476 A1
(43) Pub. Date: Dec. 20, 2007

(54) Method For Representing Foreign RAID Configurations

(76) Inventors: Vance E. Corn, Austin, TX (US); John Dodson, Pflugerville, TX (US); William C. Edwards, Round Rock, TX (US); Scott A. Lenharth, Austin, TX (US)

Correspondence Address: HAMILTON & TERRILE, LLP, P.O. BOX 203518, AUSTIN, TX, 78720, US

(21) Appl. No.: 11/424,593

(22) Filed: Jun. 16, 2006

(51) Int. Cl. G06F 12/16

(52) U.S. Cl. 711/114

(57) ABSTRACT

A system and method for previewing a disk drive's disk data format (DDF) metadata before performing an “import” or “clear” method to make it available on a receiving system comprising a redundant array of independent disks (RAID) array. A preview method is implemented such that the DDF metadata of one or more disk drives comprising a foreign configuration can be examined prior to importing or clearing the disk. New objects are derived from existing virtual disk and physical disk array objects that have the same characteristics as existing object definitions. These new objects are aggregated to comprise a new foreign configuration object when foreign metadata is discovered on a drive by a receiving RAID controller.

### BACKGROUND OF THE INVENTION

1. Field of the Invention

The present invention relates in general to the field of information handling systems and, more specifically, to managing disk storage.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The amount of data that information handling systems manage continues to grow, driving the need for scalable data storage systems capable of sustaining information integrity, reliability and availability. One approach to address these needs is the implementation of redundant array of independent disks (RAID) subsystems, which can share or replicate data across multiple disk drives, any of which can be replaced (“hot swapped”) without powering the system down if they fail. In its simplest implementation, RAID combines multiple hard drives into a common pool of storage resources that can be logically partitioned as virtual drives. RAID implementations generally involve the use of a RAID controller, which manages the disks comprising the array, and in some versions of RAID (e.g., RAID 5), may also perform parity calculations for error detection and correction. However, due to how configuration information is stored on each disk, one vendor's RAID array will usually not be able to read data created by another vendor's array. This information, called a configuration on disk (COD), typically includes assignment of physical disks to a RAID group, RAID levels of RAID groups, data mapping of RAID groups, and hotspare assignments. Currently, each RAID vendor implements its own proprietary COD format, which prevents one vendor from determining the RAID format used for a RAID set created by another vendor.

Incompatibilities between different COD formats makes it difficult for data centers to consolidate or redistribute their RAID resources, as disks cannot be physically moved from one RAID system to another. If attempted, the data they contain can be lost or corrupted during the migration process. For example, if a disk is moved from one RAID system to a system from a different vendor, the disk's format will likely be read as unrecognized or blank by the new RAID controller. Furthermore, disk signatures may be written to the disk during the process, destroying the data it holds, or a new RAID group may be created over the existing data, likewise resulting in loss of data. In response to these and other RAID issues, the Storage Network Industry Association (SNIA) has developed the Disk Data Format (DDF) specification, which standardizes RAID configuration data structures. As such, DDF collectively describes how data is formatted and distributed across disks in a RAID group as well as virtual disk configurations such as RAID levels, participating disks, stripe sizes, and cache policies.

DDF also provides basic levels of interoperability between RAID systems from different vendors by enabling the DDF structure stored on each of its disks to be recognized and read by other DDF-compliant systems, regardless of their manufacturer. While this approach helps prevent random disks from being mixed into a RAID group from a different configuration, issues remain. For example, if a physical disk has been configured in a virtual disk or as a hotspare on a RAID controller that supports DDF, the configuration information is stored on the drive as metadata that is readable by other DDF systems. But if the drive is moved to a different controller, this metadata is considered to be “foreign” and must either be “imported” or “cleared” to make the drive available for use in the new system. An “import” merges the foreign configuration into the receiving RAID controller's active configuration, allowing the virtual disks defined by the foreign DDF metadata to be made available to the system. Conversely, a “clear” makes the drives available to the receiving system for assignment in a new virtual disk. Ideally, the user should be able to preview each drive's DDF metadata to determine its virtual disk RAID type, its current state, and whether it is designated as a hotspare before deciding whether to blindly execute an “import” or “clear” operation. However, current storage management consoles do not allow a user to preview foreign DDF RAID configurations before they are either “cleared” or “imported.” Instead, the user must do a blind, global “import” or “clear.” In view of the foregoing, there is a need for previewing a disk's DDF metadata before performing an “import” or “clear” operation.

### SUMMARY OF THE INVENTION

In accordance with the present invention, a system and method is disclosed for previewing a disk drive's Disk Data Format (DDF) metadata before performing an “import” or “clear” operation to make it available on a receiving system comprising a redundant array of independent disks (RAID) array. In different embodiments of the invention, a preview method is implemented such that the DDF metadata of one or more disk drives comprising a foreign configuration can be examined prior to importing or clearing the disk. In these embodiments of the invention, a foreign configuration object comprises a disk group that shares a set of virtual disks or hotspares. For example, each disk group discovered by previewing a drive's DDF metadata represents a separate instance of a foreign configuration object. In an embodiment of the invention, “import” and “clear” methods are implementable on foreign configuration objects.

In another embodiment of the invention, new objects are derived from existing virtual disk and physical disk array objects that have the same characteristics as existing object definitions. However, in this embodiment of the invention, no methods (e.g., import, clear) are available for implementation. These new objects are aggregated to comprise a new foreign configuration object when foreign metadata is discovered on a drive by a receiving RAID controller. In an embodiment of the invention, DDF metadata of a disk drive is previewed to detect information about foreign configuration objects including, but not limited to, virtual disk configurations such as RAID levels, participating disks, stripe sizes, and cache policies.

In one embodiment of the invention, DDF metadata comprising a foreign disk drive is previewed such that it is determined that the foreign configuration objects it contains are intended to be “imported” and made available as data resources comprising a RAID array. In another embodiment of the invention, DDF metadata comprising a foreign disk drive is previewed such that it is determined that the foreign configuration objects it contains is no longer required and that the disk is available to be “cleared” and made available as free storage capacity on a RAID array. In yet another embodiment of the invention, DDF metadata comprising a foreign disk drive is previewed such that the foreign configuration objects it contains are individually “imported” or cleared, with “imported” objects made available as data resources comprising a RAID array, and the disk capacity formerly assigned to “cleared” objects is made available for reuse. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention;

FIG. 2 is a generalized block diagram of a Redundant Array of Independent Disks (RAID) environment implemented in a hotswap environment in accordance with an embodiment of the invention;

FIG. 3 is a generalized block diagram of a RAID environment implemented in a migration environment in accordance with an embodiment of the invention; and

FIG. 4 is a generalized flowchart illustrating a RAID foreign configuration preview system as implemented in accordance with an embodiment of the invention.

### DETAILED DESCRIPTION

In accordance with the present invention, a system and method is disclosed for previewing a disk drive's disk data format (DDF) metadata before performing “import” or “clear” operations to make it available on a receiving system comprising a redundant array of independent disks (RAID) array. In different embodiments of the invention, a preview method is implemented such that the DDF metadata of one or more disk drives comprising a foreign configuration can be examined prior to performing “import” or “clear” methods on the disk.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

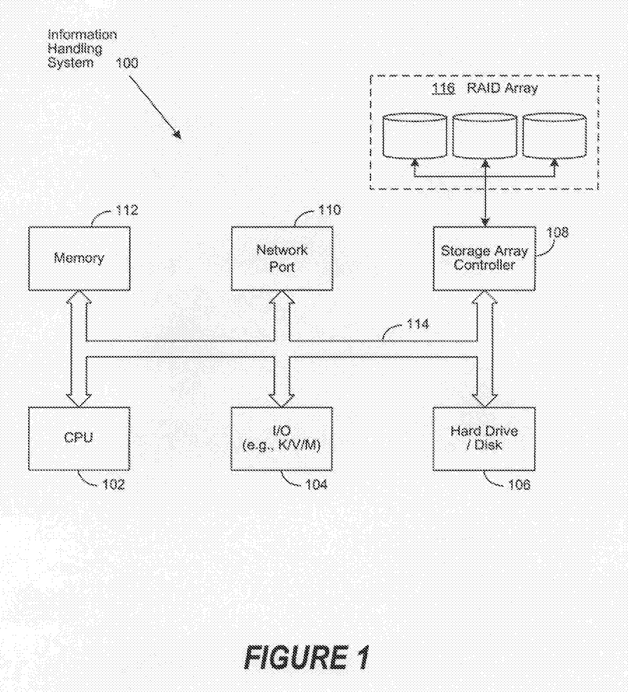

FIG. 1 is a generalized illustration of an information handling system 100 that can be used to implement the system and method of the present invention. The information handling system comprises a processor 102, input/output (I/O) devices 104, such as a display, a keyboard, a mouse, and associated controllers, a hard disk drive 106, other storage devices 108, such as a floppy disk and drive and other memory devices such as a storage array controller, various other subsystems 110, and network port 114, all interconnected via one or more buses 112. In one embodiment of the invention, storage array controller 108 manages two or more disk drives comprising a redundant array of independent disks (RAID) subsystem 116.

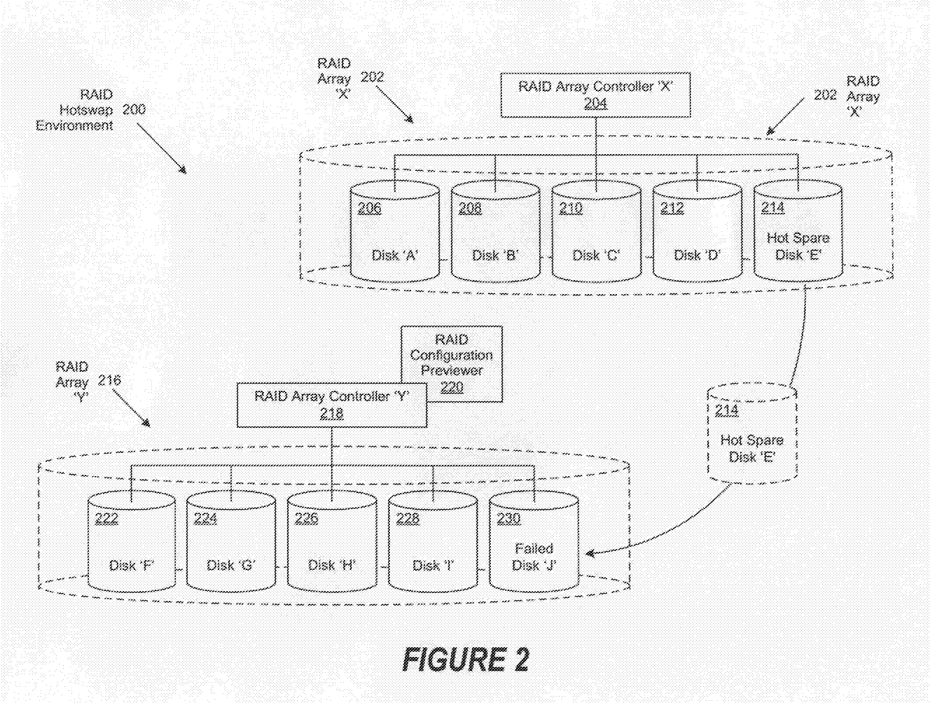

FIG. 2 is a generalized block diagram of a Redundant Array of Independent Disks (RAID) environment 200 implemented in a hotswap environment in accordance with an embodiment of the invention. In this embodiment of the invention, RAID environment 200 comprises RAID array ‘X’ 202 and RAID array ‘Y’ 216. RAID array ‘X’ 202 comprises RAID array controller ‘X’ 204, disks ‘A’ 206, ‘B’ 208, ‘C’ 210, ‘D’ 212, and hot spare disk ‘E’ 214. RAID array ‘Y’ 216 comprises RAID array controller ‘Y’ 218, RAID configuration previewer 220, disks ‘F’ 222, ‘G’ 224, ‘H’ 226, ‘I’ 228, and failed disk ‘J’ 230.

In this same embodiment of the invention, disk ‘J’ 230 comprising RAID array ‘Y’ 216 fails and requires replacement. To replace it, hot spare disk ‘E’ 214 is physically removed from RAID array ‘X’ 202 and transferred to RAID array ‘Y’ 216. As hot spare disk ‘E’ 214 is coupled to RAID array ‘Y’ 216, it is recognized by RAID array controller ‘Y’ 218 as a foreign configuration, thereby signifying that it requires importing if its contents are to be made available as part of RAID array ‘Y’ 216, or clearing if it is to be made available as free storage capacity. In one embodiment of the invention, RAID configuration previewer 220 is implemented to preview DDF metadata comprising hot spare disk ‘E’ 214 such that it is determined whether any data it contains is intended to be “imported” and made available as data resources comprising RAID array ‘Y’ 216, or “cleared” and made available as free storage capacity. It will be apparent to those of skill in the art that the contents of hot spare disk ‘E’ 214 are currently not viewable without implementation of RAID configuration previewer 220.

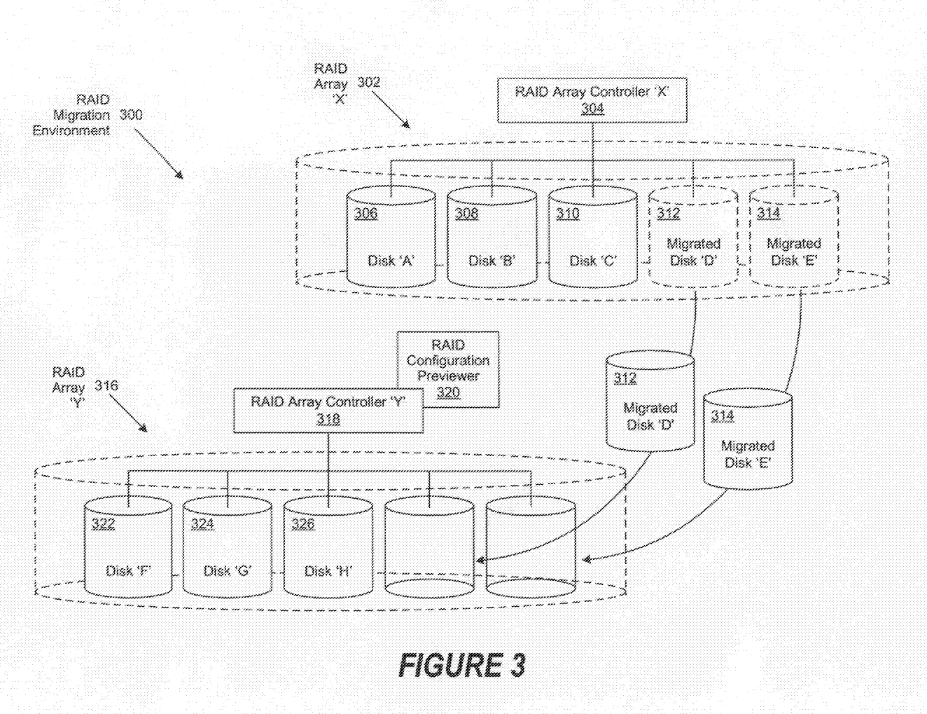

FIG. 3 is a generalized block diagram of a Redundant Array of Independent Disks (RAID) environment 300 implemented in a migration environment in accordance with an embodiment of the invention. In this embodiment of the invention, RAID environment 300 comprises RAID array ‘X’ 302 and RAID array ‘Y’ 316. RAID array ‘X’ 302 comprises RAID array controller ‘X’ 304, disks ‘A’ 306, ‘B’ 308, ‘C’ 310 and migrated disks ‘D’ 312 and ‘E’ 314. RAID array ‘Y’ 316 comprises RAID array controller ‘Y’ 318, RAID configuration previewer 320, disks ‘F’ 322, ‘G’ 324 and ‘H’ 226. In this same embodiment of the invention, disks ‘D’ 312 and ‘E’ 314, formerly comprising RAID array ‘X’ 202, are migrated to RAID array ‘Y’ 316. As migrated disks ‘D’ 312 and ‘E’ 314 are coupled to RAID array ‘Y’ 316, they are recognized by RAID array controller ‘Y’ 318 as a foreign configuration, thereby signifying that they require importing if their contents are to be made available as part of RAID array ‘Y’ 316, or require clearing if they are to be made available as free storage capacity.

In one embodiment of the invention, RAID configuration previewer 320 is implemented to preview DDF metadata comprising migrated disks ‘D’ 312 and ‘E’ 314 such that it is determined that the data they contain is intended to be “imported” and made available as data resources comprising RAID array ‘Y’ 316. In another embodiment of the invention, RAID configuration previewer 320 is implemented to preview DDF metadata comprising migrated disks ‘D’ 312 and ‘E’ 314 such that it is determined that the data they contain is no longer required and that the disks are available to be “cleared” and made available as free storage capacity on RAID array ‘Y’ 316. It will be apparent to those of skill in the art that the contents of hot spare disk ‘E’ 214 are currently not viewable without implementation of RAID configuration previewer 220.

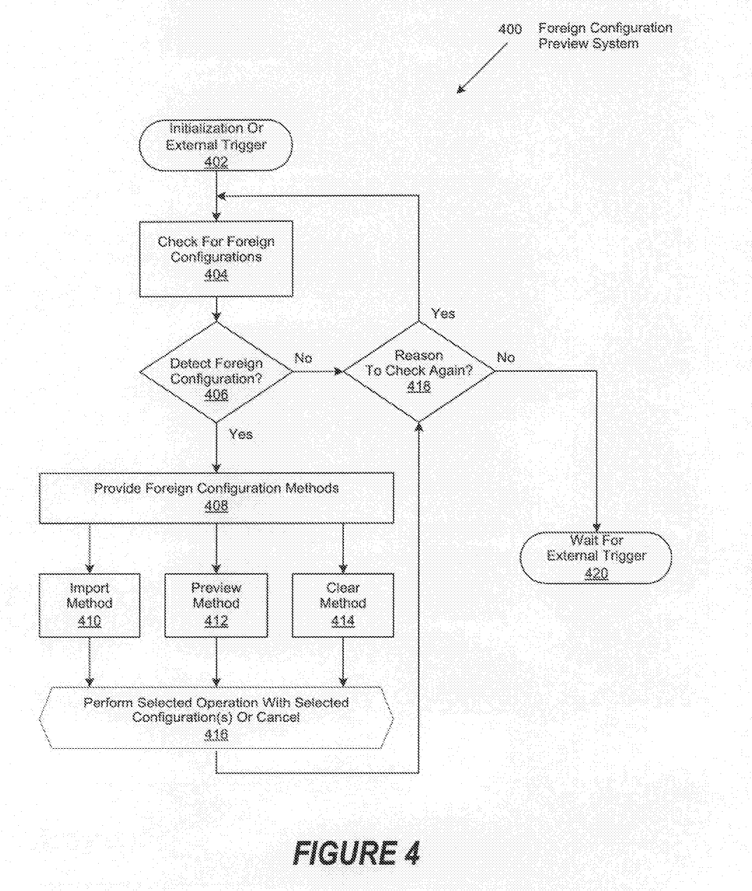

FIG. 4 is a generalized flowchart illustrating a Redundant Array of Independent Disks (RAID) foreign configuration preview system 400 as implemented in accordance with an embodiment of the invention. In this embodiment of the invention, foreign configuration preview system 400 is initialized or triggered by an external event in step 402 such as, but not limited to, the mounting of a disk drive into a redundant array of independent disks (RAID) array. In step 404, the disk is examined to detect foreign configurations, generally defined as comprising a disk group that shares a set of virtual disks or hotspares. As an example, each disk group discovered by previewing a drive's disk data format (DDF) metadata represents a separate instance of a foreign configuration object.

If a foreign configuration object is detected in step 406, foreign configuration methods are implemented in step 408 to include “import” method in step 410, preview method in step 412, and “clear” method in step 414. One or more predetermined methods (i.e., steps 410, 412, 414) are then implemented in step 416 with each detected foreign configuration, or “cancelled” if “import” 410 or “clear” 414 methods are declined. For example, the DDF metadata of a detected disk is examined by implementation of preview method in step 412 to identify a plurality of foreign configuration objects. Each object is then either “imported” by implementation of “import” method in step 410 or “cleared” by implementation of “clear” method in step 414. The process continues in Step 416 until all identified foreign configuration objects have either been “imported” and made available as part of a RAID array or “cleared” such that their related disk capacity is made available for creation of a new RAID array.

Once all foreign configuration objects have either been “imported”, r “cleared”, or deferred for later action by a “cancel” operation in step 416, it is determined in step 418 whether to continue to check for the presence of foreign configuration objects. If it is determined in step 418 to continue checking, then the process continues beginning with step 404, otherwise the foreign configuration preview system enters a dormant mode in step 420 to wait for an external trigger to begin the process once again. If a foreign configuration object is not detected in step 406, then it is determined in step 418 whether to continue to check for the presence of foreign configuration objects. If it is determined in step 418 to continue checking, then the process continues beginning with step 404, otherwise the foreign configuration preview system enters a dormant mode in step 420 to wait for an external trigger to begin the process once again.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. An information handling system, comprising:
a processor operable to process data; and
storage media operable to store data for processing by said processor, said storage media comprising a plurality of storage disks configured in a RAID array, said storage disks comprising at least one foreign configuration object and associated foreign data;
wherein said processor is operable to detect configuration information corresponding to said foreign configuration object and to selectively process said associated foreign data based on said configuration information.

2. The information handling system of claim 1, wherein said configuration data is used to generate a configuration preview for a user.

3. The information handling system of claim 1, wherein based on said configuration information, said processor clears said foreign data.

4. The information handling system of claim 1, wherein based on said configuration data, said processor imports said foreign data.

5. The information handling system of claim 1, wherein said foreign configuration object comprises information relating to virtual disk configurations.

6. The information handling system of claim 1, wherein said foreign configuration object comprises information relating to RAID levels.

7. The information handling system of claim 1, wherein said foreign configuration object comprises information relating to participating disks.

8. A method of managing a data storage system, comprising:
configuring a plurality of data storage disks in a RAID array, said storage disks comprising at least one foreign configuration object and associated foreign data;
detecting configuration information corresponding to said foreign configuration object;
using said configuration data to generate a configuration preview of said foreign configuration object; and
using said configuration preview to selectively process said associated foreign data based on said configuration information.

9. The method of claim 8, wherein based on said configuration information, said processor clears said foreign data.

10. The method of claim 8, wherein based on said configuration data, said processor imports said foreign data.

11. The method of claim 8, wherein said foreign configuration object comprises information relating to virtual disk configurations.

12. The method of claim 8, wherein said foreign configuration object comprises information relating to RAID levels.

13. The method of claim 8, wherein said foreign configuration object comprises information relating to participating disks.

14. A data storage system, comprising:
plurality of storage disks configured in a RAID array, said storage disks comprising at least one foreign configuration object and associated foreign data;
a processing entity operable to detect configuration information corresponding to said foreign configuration object and to generate a configuration preview therefrom, wherein said processing entity is further operable to receive a user input in response to said configuration preview and to selectively process said associated foreign data based on said user input.

15. The data storage system of claim 14, wherein said configuration data comprises disk data format (DFF) metadata.

16. The data storage system of claim 14, wherein based on said configuration information, said processor clears said foreign data.

17. The data storage system of claim 14, wherein based on said configuration data, said processor imports said foreign data.

18. The data storage system of claim 14, wherein said foreign configuration object comprises information relating to virtual disk configurations.

19. The data storage system of claim 14, wherein said foreign configuration object comprises information relating to RAID levels.

20. The data storage system of claim 14, wherein said foreign configuration object comprises information relating to participating disks.
